(19) United States
(12) Patent Application Publication
(10) Pub. No.: US 2019/0272447 A1
(43) Pub. Date: Sep. 5, 2019

(54) MACHINE LEARNING ARTIFICIAL CHARACTER GENERATION

(71) Applicant: Hong Kong Applied Science and Technology Research Institute Co., Ltd., Shatin (HK)

(72) Inventors: Siu Kit Wong, Tsim Sha Tsui (HK); Man Kin Lau, Homantin (HK)

(21) Appl. No.: 15/912,355

(22) Filed: Mar. 5, 2018

(51) Int. Cl. G06K 9/62; G06T 11/20

(52) U.S. Cl. CPC G06K 9/6256; G06K 2209/011; G06T 11/203

(57) ABSTRACT

Embodiments of the technology discussed herein address problems of traditional electronic character recognition training by artificially generating handwriting in a unique way according to machine learning techniques that transform handwriting samples according to generative rules and discriminative rules. Solutions provided herein produce a wide range of artificially generated handwriting that appears to be human generated handwriting. As such, embodiments herein provide additional characters for a system's character bank that are obtained more efficiently, as compared to traditional techniques. Further, embodiments herein are designed to be suitable for machine learning, and as such, the techniques grow ever more efficient as the techniques are performed. In short, the solutions provided herein improve the computing technology itself in a manner that makes robust electronic Chinese character recognition feasible.

### TECHNICAL FIELD

The present disclosure relates to artificial neural networks and artificially generating character based handwriting, alphanumeric based handwriting, and calligraphy. Embodiments discussed below artificially generate handwriting according to machine learning techniques that transform sample handwriting according to generative rules and discriminative rules, thereby producing artificially generated handwriting that appears to be human generated handwriting.

### BACKGROUND OF THE INVENTION

Character recognition is an important application of artificial neural networks. Character recognition applications recognize text in documents as well as symbols and characters in industrial applications. When creating an accurate artificial neural network, the system undergoes character recognition training, which is a long and tedious process. Typically, actual handwritten samples are repetitively provided to the system to build a bank of characters that the system will recognize. Further, tests are repeatedly performed to determine whether the system properly interprets the handwritten input.

This prolonged process is time consuming and exhausts an enormous amount of computing resources because a wide range of handwriting styles exist, and the industry desires robust systems that recognize an abundant range of writing styles. The vast range of recognizable handwriting styles sought by the industry cause character recognition training to be prohibitively expensive, simply due to the sheer number of handwriting samples that traditionally needed to be obtained. Moreover, some languages, for example Chinese languages, include an unusually large number of characters, which causes exponentially more computing expense, time consumption, and financial expenditure in order to create and maintain an artificial neural network capable of recognizing a sufficient variety of handwritten Chinese characters.

### BRIEF SUMMARY OF THE INVENTION

Due to the vast variety of handwriting styles and the limitations of computer processing, there is a need to improve the technical process of character recognition training in order to decrease the cost of character recognition training, increase the speed of character recognition training, and improve the reliability of character recognition training. Improving the technical process of character recognition training provides a needed advancement to the computing industry and makes robust electronic Chinese character recognition feasible.

Embodiments of the technology discussed herein address problems of traditional electronic character recognition training by artificially generating handwriting in a unique way according to machine learning techniques that transform handwriting samples according to generative rules and discriminative rules. Solutions provided herein produce a wide range of artificially generated handwriting that appears to be human generated handwriting. As such, embodiments herein provide additional characters for a system's character bank that are obtained more efficiently, as compared to traditional techniques. Further, embodiments herein are designed to be suitable for machine learning, and as such, the techniques grow ever more efficient as the techniques are performed. In short, the solutions provided herein improve the computing technology itself in a manner that makes robust electronic Chinese character recognition feasible.

Embodiments include a method that progressively trains a computer to artificially generate recognizable handwritten characters. An example method comprises receiving a digitized seed character comprising pixels, choosing at least one feature of the seed character, determining a probability distribution of the pixels of the chosen feature, and artificially generating deformed characters. Example methods artificially generating deformed characters at least by performing physiognomy gridline repositioning based on positions of the pixels, defining alignment classifiers based at least on the gridline repositioning, identifying deformation classifiers based at least on the alignment classifiers, selecting one or more deformational rules from a deformational rule bank based at least on the deformation classifiers, and deforming the digitized seed character according to the selected one or more deformational rules. Example methods may further comprise collecting accuracy data, and altering the selecting step based at least on the accuracy data.

Embodiments also include a non-transitory computer-readable medium having program code recorded thereon for progressively training a computer to artificially generate recognizable handwritten characters. Example the program code comprises code to receive a digitized seed character comprising pixels, code to choose at least one feature of the seed character, code to determine a probability distribution of the pixels of the chosen feature, and code to artificially generating deformed characters. Code to artificially generate deformed characters may at least include performing physiognomy gridline adjusting based on positions of the pixels, defining alignment classifiers based at least on the gridline repositioning, identifying deformation classifiers based at least on the alignment classifiers, selecting one or more deformational rules from a deformational rule bank based at least on the deformation classifiers, and deforming the digitized seed character according to the selected one or more deformational rules. Example mediums may further include code to collect accuracy data, and code to alter the selecting step based at least on the accuracy data.

Embodiments may also include a system that progressively trains machine learning to artificially generate recognizable handwritten characters. Example systems may comprise one or more memory and one or more processor that receives a digitized seed character comprising pixels, chooses at least one feature of the seed character, determines a probability distribution of the pixels of the chosen feature, and artificially generates deformed characters. an example system may artificially generates deformed characters at least by performing physiognomy gridline adjusting based on positions of the pixels, defining alignment classifiers based at least on the gridline repositioning, identifying deformation classifiers based at least on the alignment classifiers, selecting one or more deformational rules from a deformational rule hank based at least on the deformation classifiers, and deforming the digitized seed character according to the selected one or more deformational rules. In embodiments, the one or more processor may further collect accuracy data and alter the selecting step based at least on the accuracy data.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIGS. 1A and 1B show examples of prior art techniques;

FIG. 2A shows an example technique that artificially generates characters;

FIGS. 2B-2D show an example technique that artificially generates characters;

FIGS. 3A and 3B show examples that artificially generate characters;

FIG. 4 shows an example that artificially personalizes artificially generated characters;

FIG. 5 shows an example computer system; and

APPENDIX A shows example deformational rules.

### DETAILED DESCRIPTION OF THE INVENTION

Techniques are described herein that improve the technical process of electronic character recognition training, which may involve character based handwriting, alphanumeric based handwriting, calligraphy, symbols, and/or the like. Embodiments may involve artificial neural networks, artificial intelligence systems, computer systems, a computer, and/or the like. A preferred embodiment improves the technical process of training an artificial neural network in Chinese character recognition.

One of the most expensive and time consuming steps of teaching a computer to recognize handwritten characters is building a character bank having a sufficient range of various handwriting styles for each character. Conventional character banks were populated with samples of handwritten characters that were written by humans. Traditionally, in order to increase the variety of handwriting styles, more and more samples were obtained from more and more humans, and the human written samples were scanned into a computer and stored in a character bank.

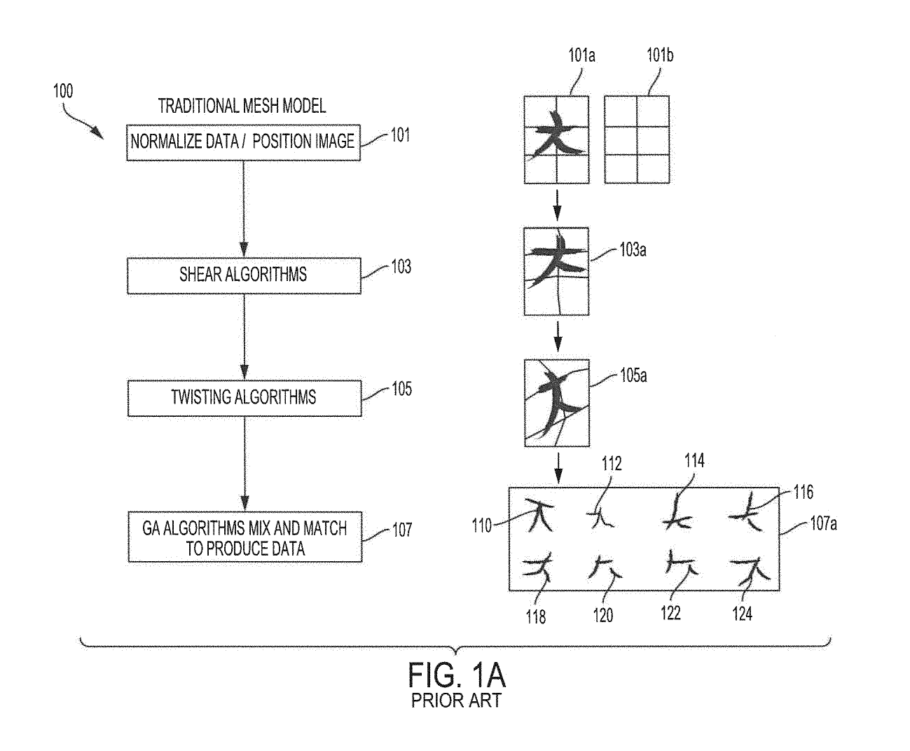

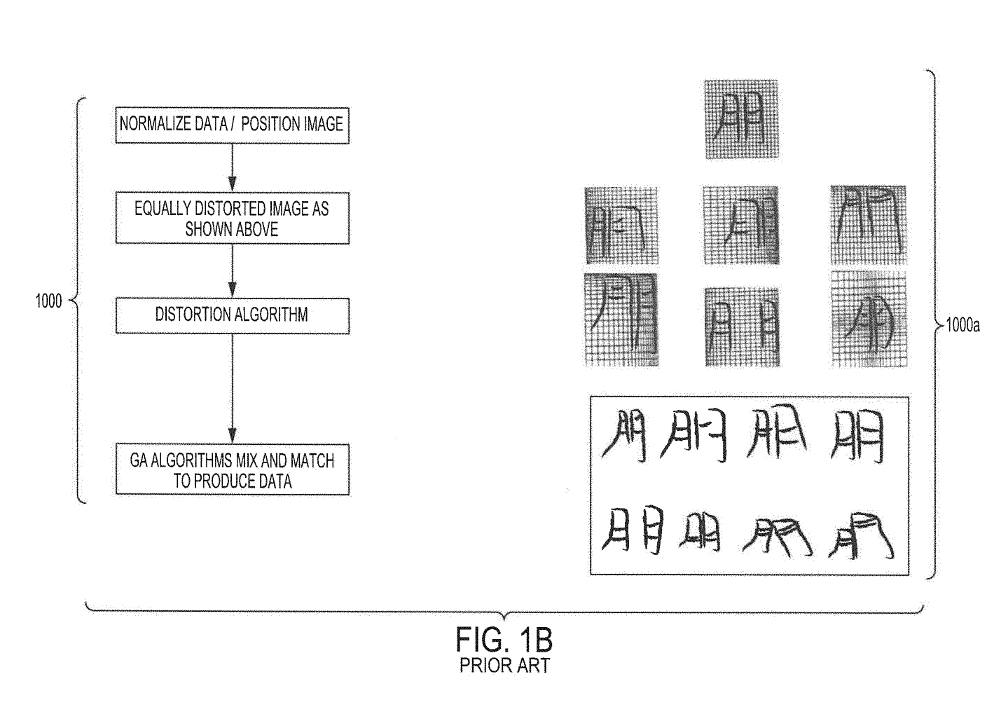

This process was too slow and too costly, so the industry began increasing the character bank by electronically manipulating characters of the character bank using computer graphics techniques in an attempt to synthetically increased the variety of handwriting styles. FIG. 1A shows an example of traditional character mesh modeling 100, which synthetically created handwritten characters. Typically, at step 101, a character that was written by hand is positioned and normalized within a two dimensional mesh, for example a 3×2 mesh of blocks 101b. Image 101a shows an example image of step 101. Then, the technique distorts the character using computer graphics techniques. For example, in step 103, shear techniques are applied to the character, which distort the character as shown in image 103a. In step 105, twisting techniques are used to further distort the character as is shown in image 105a. Traditionally, genetic algorithms (GA) are performed (step 107) to cause a wide variety of compounded malformations, which synthesize a wide variety of distorted characters as is shown in image 107a.

Conventionally, the variety of distorted characters 107a are individually tested for acceptability to determine whether a respective distorted character is an acceptable variation of the original character 101a. For example, distorted character 110 is compared to handwritten character 101a. If distorted character 110 is determined to be sufficiently similar to handwritten character 101a and sufficiently distinguishable from other characters such that a human would recognize the intended meaning of character 110, then character 110 is determined to be a sufficient variant of handwritten character 101a. Typically, sufficient variants of handwritten characters are added to the character bank.

While traditional techniques are capable of producing some sufficient variants of handwritten characters, the traditional techniques produce a high quantity of unrecognizable characters, as is seen in box 107a. Handwritten character 101a has the English meaning “big.” Synthetically created character 110 would not be recognized by a human as meaning big. Rather, synthetically created character 110 would likely be recognized by a human as being gibberish. Similarly, synthetically created characters 116 and 124 would likely be considered gibberish. Synthetically created character 112 would not likely be recognized by a human as having the English meaning big; rather, synthetically created character 112 would likely be recognized by a human as having the English meaning “nine (9)”. Likewise, synthetically created character 122 would likely be recognized as having the English meaning “nine (9)”, while synthetically created character 120 would likely be recognized as having the English meaning “six (6)”. Moreover, synthetically created character 114 would likely be recognized by a human as being an English alphanumeric cursive letter “k”. Of all the synthetically created characters of box 107a, character 118 is the most likely to be recognized by a human as having the English meaning big. As a result, only one synthetically created character 118, of all the synthetically created characters 107a, would be added to a character bank. Furtherly disappointing, feeding inaccurately synthetically created handwriting into a system may negatively affect a model's accuracy.

FIG. 1B shows another traditional attempt, process 1000, at synthetically created characters 1000a, which are intended to synthesize various handwriting styles. As can be seen from FIGS. 1A-1B, traditionally synthetized characters are of poor quality and yield a low amount of characters that are sufficiently recognizable to be added to a character bank. Thus, while synthetically creating characters to increase the variety of characters in a character bank may be quicker and snore cost-effective than obtaining and uploading human written characters, there is a need for solutions that improve traditional synthetic character creating techniques.

At least one problem with traditional synthetic character creation techniques is that traditional techniques force the character to normalize to the grid. Then, the techniques use brute force to create as many character distortions as possible using as many combinations of gridline malformations as possible. This process is slow due to computing limitations. Then, after generating as many character distortions as possible, traditional techniques expend yet more computing resources to filter out the unrecognizable distorted Characters and keep the recognizable distorted characters. This process is also slow due to computing limitations. In short, traditional character distorting techniques produce a low number of recognizable characters, yet the techniques consume a comparatively large amount of computing resources and time. As such, a more efficient method is desired to improve conventional handwritten character recognition training processes.

Improvements to traditional techniques may be realized by focusing on the physiognomies of a character prior to performing deformation techniques. By focusing on the physiognomies of a particular character, a system may proactively and intelligently determine which combination of deformational rules, of a larger pool of deformational rules, are likely to create artificially generated characters that are recognizable. The techniques described herein improve the efficiency of handwriting and calligraphy generation techniques by reducing the number and combination of deformational rules performed. Instead of using brute force, solutions described herein limit computer processing to a selective combination of deformational rules that are selected based at least on the physiognomies of a particular character, thereby avoiding the waste of resources caused by brute force computations. Further still, embodiments herein are designed to be suitable for machine learning, and as such, the techniques grow ever more efficient as the techniques are performed. In short, the solutions provided herein improve the computing technology itself in a manner that makes robust electronic Chinese character recognition feasible.

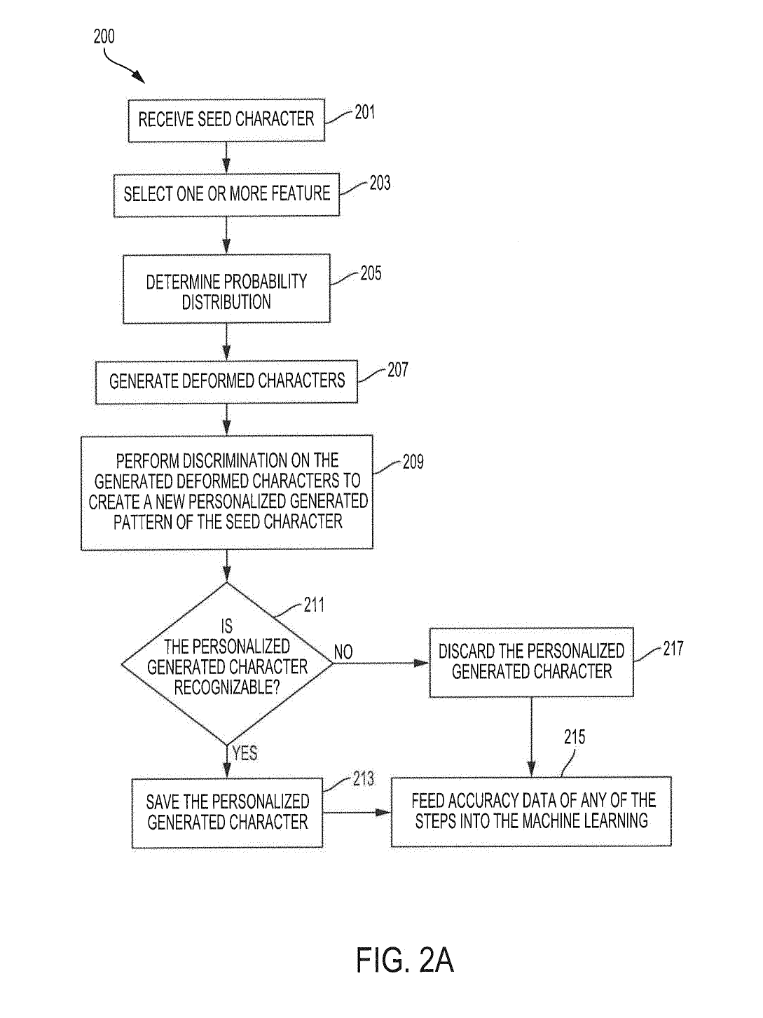

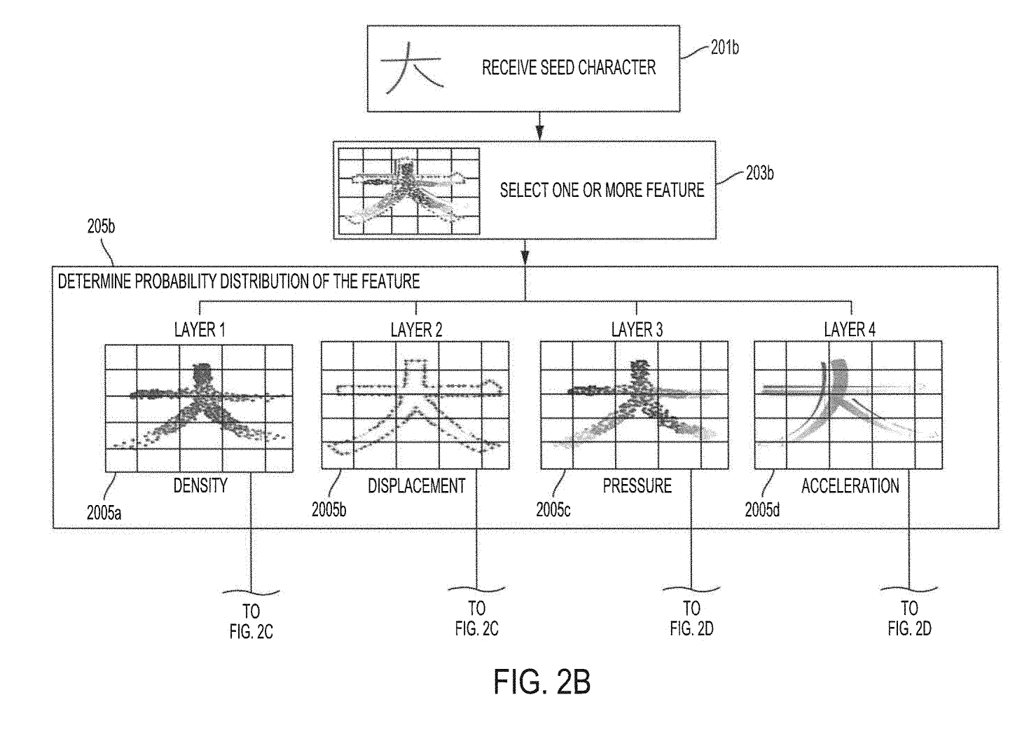

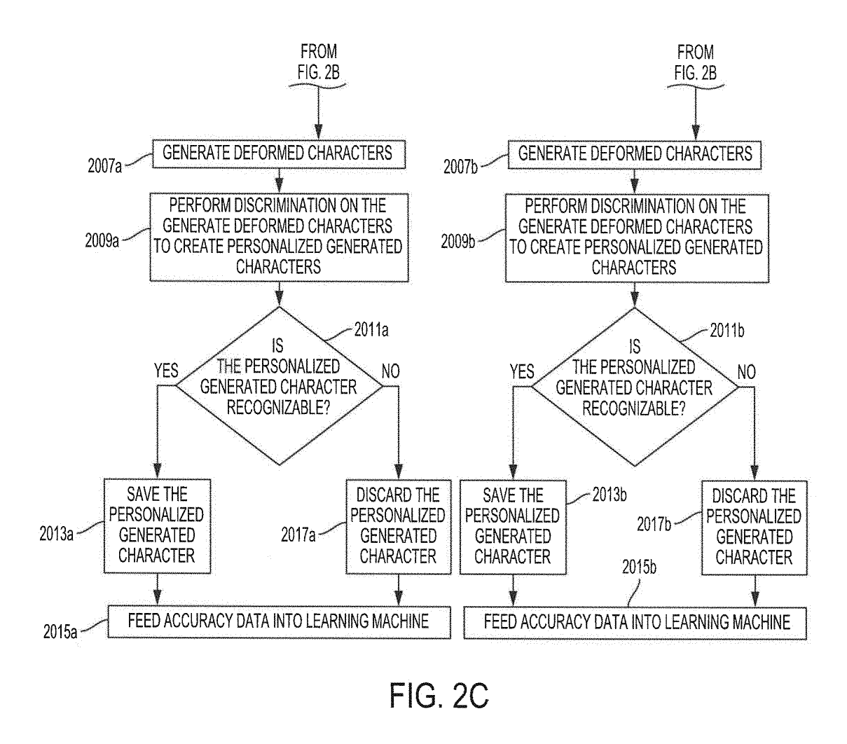

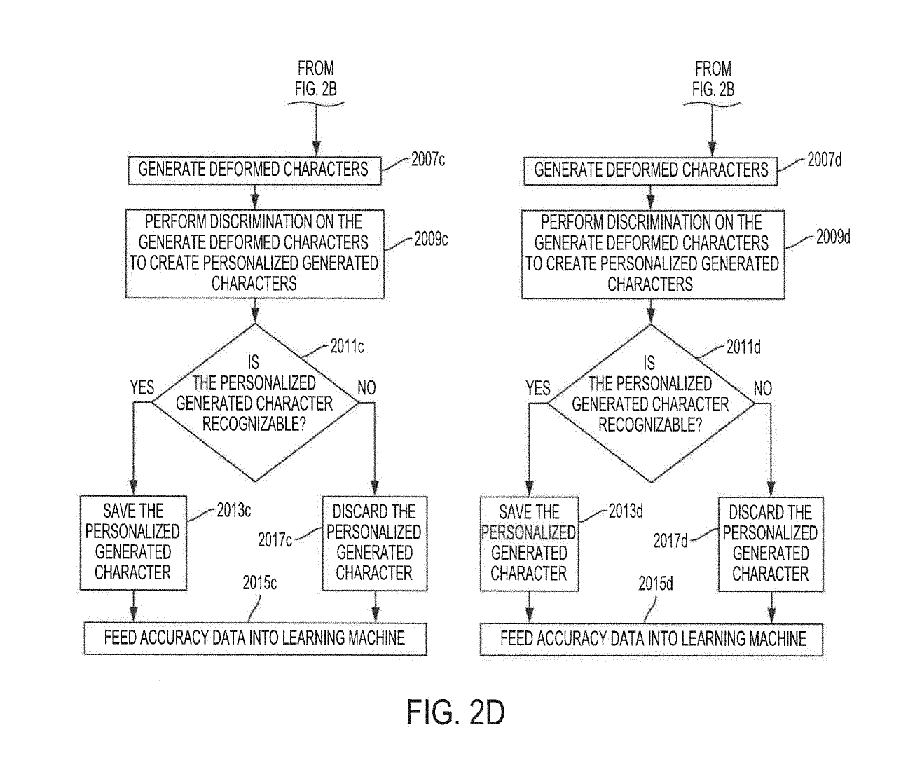

FIG. 2A shows a high level example of an improved technique 200, the details of which will be discussed in at least some of the following figures. Various steps of technique 200 may be performed by one or more processor. At step 201, a system receives a seed character. Examples of seed characters are hand written characters that have been scanned into the system, recognizable characters that have previously been computer generated, characters from a character bank, and/or the like. A seed character may be a Chinese character, another language character, alphanumeric character, calligraphy, a signature, and/or the like.

At step 203, a system may select a feature of the seed character. Example features include, but are not limited to, displacement, density, pressure, acceleration, and/or the like. A processor performing steps of method 200 may select a single feature or multiple features of the seed character. In an example that selects multiple features, step 203 may select multiple features for multilayer processing, which is discussed in greater detail below at least with reference to FIG. 2B. At step 205, a system determines a probability distribution of the selected feature of the seed character. Step 205 is also described in greater detail below at least with reference to FIG. 2B.

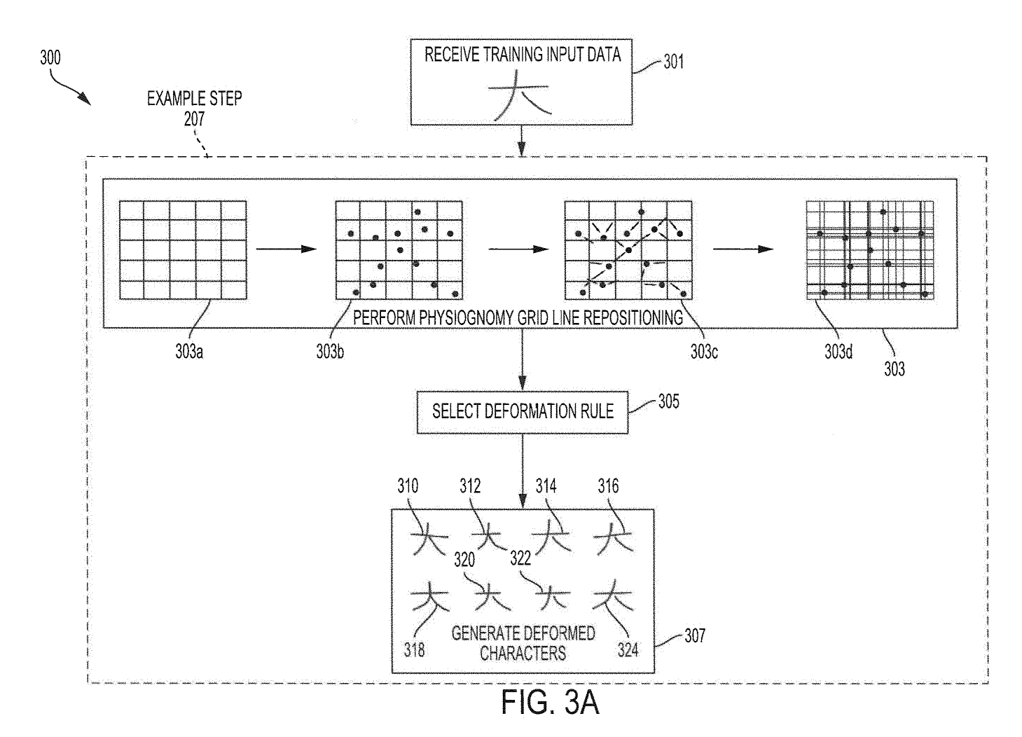

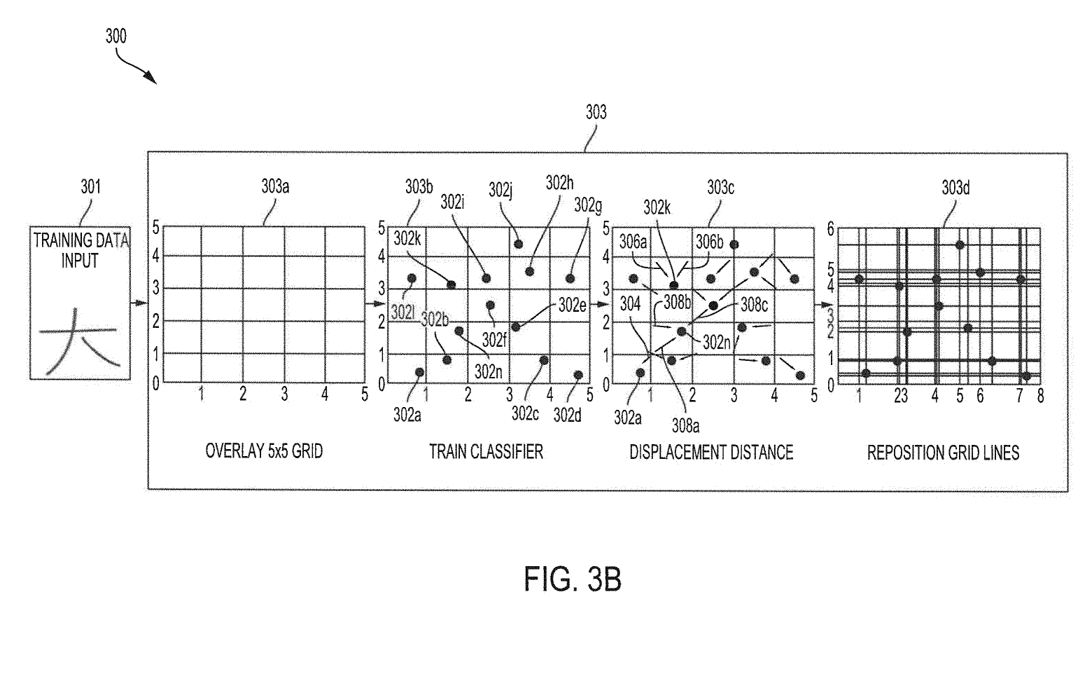

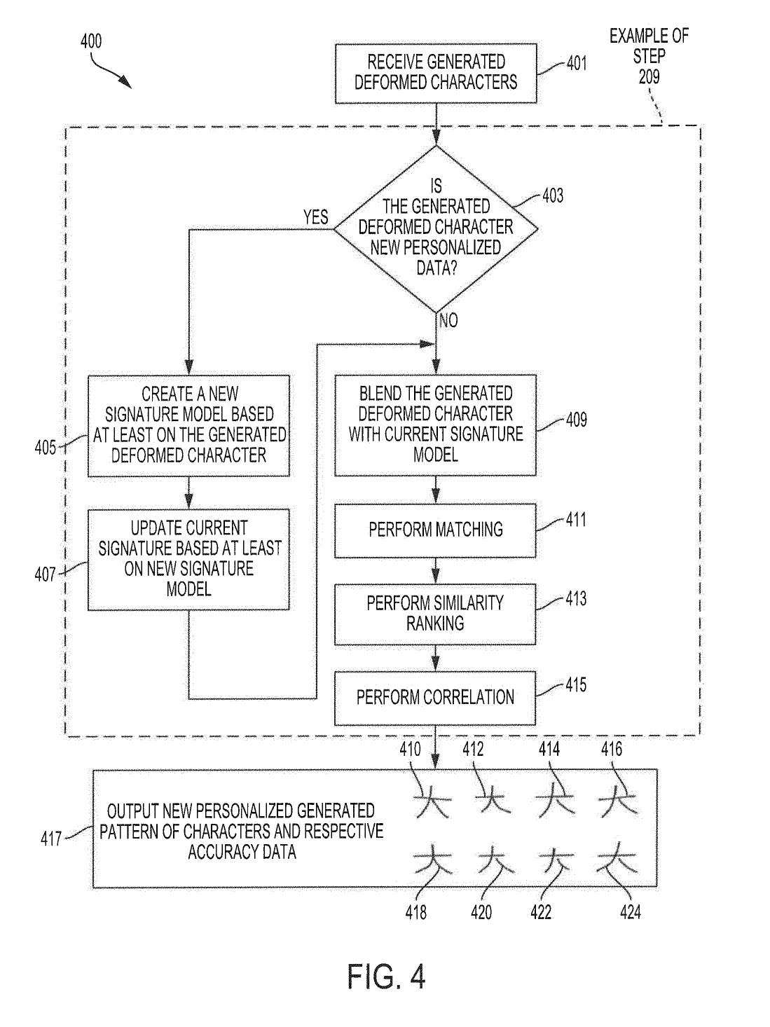

At step 207, generation is performed wherein a system generates deformed characters from the seed character. Step 207 is described in greater detail below at least with reference to FIGS. 3A-3B. At step 209, a system performs discrimination on the artificially generated deformed characters to create a new personalized generated pattern of the seed character. Step 209 is described in greater detail below at least with reference to FIG. 4. During step 209 (or any step disclosed herein), accuracy testing data may be accumulated for each respective new personalized generated pattern, and some or all of the accuracy data may be fed into one or more machine learning module, so the system may continually learn from various steps described herein.

At step 211, a system determines whether a new personalized generated pattern of the seed character is sufficiently recognizable as the seed character. For example, if the seed character was the alphanumeric letter “A”, at step 211 the system determines whether a new personalized generated pattern of the seed character “A” is recognizable as the letter “A.” If multiple new personalized generated patterns of the seed character have been received at step 211, the system may perform step 211 for each of the received new personalized generated patterns of the seed character.

If at step 211, the system determines that a new personalized generated pattern of the seed character is sufficiently recognizable as the seed character, then at step 213, the system may save the new personalized generated pattern of the seed character. In examples, the new personalized generated pattern may be added to a character bank thereby increasing the number of characters in the character bank. If however, at step 211, the system determines that a new personalized generated pattern of the seed character is not sufficiently recognizable as the seed character, then at step 217, the system may discard the character. In embodiments, an unrecognizable character may be excluded from character bank. In further embodiments, an unrecognizable character, and/or information derived therefrom, may be fed into one or more machine learning modules, so the system may continually learn from failed manipulation attempts.

At step 215, the system may feed accuracy data from any of the various steps disclosed herein into one or more machine learning modules. A machine learning module may use at least accuracy data to improve any of the various steps disclosed herein. For example, accuracy data of a new personalized generated pattern of the seed character may be utilized to determine whether deformation techniques, a combination of deformation techniques, and/or a specific sequence of deformation techniques selected at step 207 are effective and/or would benefit from being changed. One or more machine learning modules may receive accuracy data at any time and during any step described herein.

FIG. 2B illustrates an example that processes multiple features of a seed character. Identifying and performing morphing techniques on multiple discrete features of a seed character may improve the yield of the processes described herein and the machine learning. In this example, the seed character is a Chinese character having the English meaning “big”, and a non-limiting example set of four features are illustrated: density, displacement, pressure, and acceleration. Step 203b shows an example set of features (density, displacement, pressure, and acceleration) in an example multilayered configuration. Step 205b shows an example of each feature in a respective individual layer. In this example, step 205b illustrates four selected layers: density layer 2005a, displacement layer 2005h, pressure layer 2005c, and acceleration layer 2005d. Each of the aforementioned features assist in the recognition of personalized handwriting. Additional layers and/or less layers may be selected, extracted, and processed, as is desired, to further assist in the recognition of personalized handwriting and/or for other purposes.

Following the steps of FIGS. 2B-2D, at step 201b, a system receives a seed character, which comprises multiple features. At step 203b, a system selects one or more features for processing. In this example, a set of four features are selected: density, displacement, pressure, and acceleration. At step 205b, a system determines the probability distribution of each selected feature. If desired, the system may parallel process step 205b, for example, according to the number of selected features. In this example, the probability distribution is determined for four different features and the features are parallel processed. Referring back to FIG. 2A, if multiple features are selected, any or all of the steps following the selection may be parallel processed. FIG. 2B shows an example of the following steps being parallel processed for each feature. For example, a system performs steps 2007a-2017a for the density feature, performs steps 2007b-2017b for the displacement feature, performs 2007e-2017c for the pressure feature, performs 2007d-2017d for the acceleration feature, and/or performs the steps for any other selected feature, as may be desired. One or more processors may be used to perform parallel processing.

FIG. 3A shows an example improved generative technique 300 that generates deformational hand written characters. At step 301, a system receives training input data. In examples, training input data may be an output of step 205, a hand written character, a character from a character bank, a generated character that has previously passed accuracy testing, and/or the like. In this example, training input data is a Chinese character that is recognizable by a human as having the English meaning “big.”

Step 303 performs physiognomy grid positioning on the training input data (e.g., a handwritten character), in order to identify alignment classifiers specific to the training input data. FIGS. 3A and 3B are discussed jointly with reference to step 303. In step 303a, the system creates a grid over the training data input. For example, step 303a overlays an n-by-n grid (e.g., 5 by 5) over the Chinese character. Preferably, the entirety of the character is captured within the grid with one dot per square, for example by ensuring the grid is sufficiently large to capture the entire character with one dot per square. In a character of a processing system, for example a binary handwritten Character (C), C comprises many pixels (p) that together make up Character (C). For illustrative purposes, FIGS. 3A-3B show a sample set of pixels (p) as dots 302a-302n. The pixels (p) of Character (C) may be represented by the following: C={, p₁, p₂, p₃. . . pₙ} where pᵢ=(xᵢ,yᵢ) is the ith pixel in Character (C) and n is the total number of pixels in C. In step 303b, all dots or a subset of dots (e.g., pixels) are identified within the grid. A system may select a sample size number of dots used at this step, as is desired, based on machine module adjustments. With the dots identified within the grid, one or more of the gridlines will be adjusted based at least on the location of the respective dots.

In step 303c, a displacement distance is calculated for some or all of the dots. The displacement distance of a dot identifies one or more vector distances of the respective dot from a nearby grid intersection. For example, dot 302a is vector 304 distance away from grid intersection (1,1); dot 302k is vector 306a distance away from grid intersection (1,4) and vector 306b distance away from grid intersection (2,4); and further, dot 302n is vector 308a distance away from grid intersection (1,1), vector 308b distance away from grid intersection (1,2), and vector 308c distance away from grid intersection (2,2). Displacement distance may be calculated for some or all of the dots.

In step 303d, the gridlines are adjusted such that the grid aligns with the dots that make up the training data input. In this example, respective gridlines split into two gridlines, and the split gridlines are positioned such that a vertical gridline and a horizontal gridline intersect the location of a respective dot. In embodiments, some or all gridlines split in order to accommodate a plurality of dots. In further embodiments, the gridlines are split and/or positioned based at least on the displacement distance of respective dots. In examples, the gridlines are adjusted, and the dots are not moved. In further examples, the gridline intersections maintain their (x,y) angle after the gridline adjustment. For example, the gridlines of 303c are orthogonal, and the gridlines of 303d remain orthogonal after the gridline adjustment. In embodiments, one or more original gridline may split into one or more gridline during the adjusting. Step 303, as a whole, performs physiognomy grid positioning that adjusts the gridlines to follow the natural physiognomies of the character. This technique is in contrast to traditional methods that adjusts the character to normalize it within a rigid square grid.

Step 303 is performed to identify classifiers. An example classifier includes alignment classifiers, which perform the adjustment of gridlines based at least on a dot's position, as is described above. Alignment classifiers include, but are not limited to, Gaussian, Naïve Bayes, Nearest neighbor HMV, Position and Displacement, and/or the like. Alignment classifiers may further include, but are not limited to Features/Support Vector Machine (SVM)/Cluster Analysis and/or Deep learning, and/or the like.

Another example classifier includes deformational classifiers that identify which deformation techniques, of a group of deformation techniques, are more likely to result in a recognizable generated character. Further, deformational classifiers may identify which deformation techniques, of a group of deformation techniques, are less likely to result in a recognizable generated character. Deformation classifiers may be based at least on information from the alignment classifications. At step 305, a system selects one or more deformational techniques to perform on the received training input data based at least on the deformational classifiers. In embodiments, the system may select one deformation technique, a combination of deformation techniques, a sequential order of a plurality of deformational techniques, and/or the like.

A system may create and/or have access to one or more deformational rule bank (e.g,, a database, index, table, and/or the like), which includes deformational rules from which a system may select. Appendix A shows a non-limiting example of a deformational rule bank. A system may adjust the deformational rules stored in one or more deformational rule bank as a machine learning module learns which rules are more effective than others based on varies factors, for example, alignment classifiers. Example deformational rules include, but are not limited to, scaling, unequal scaling, rotation, horizontal rotation, vertical rotation, shear, horizontal shear, vertical shear, hyperbolic rotation, twists, and/or the like. Further examples of deformation techniques include, but are not limited to, filter techniques, collaborative techniques, and Generic Algorithms (GA) techniques. Various deformation techniques may be combined, various deformation techniques may he performed in a certain order, and various deformation techniques may be performed one or more times in a sequence of deformation techniques.

In short, deformation classifiers proactively identifying which deformation techniques and which order and/or combination of deformation techniques are more effective than others based at least on the physiognomy of the character. By focusing on the physiognomy of the character, the system intelligently and proactively selects optimal deformational rules while avoiding other deformational rules, which reduces the amount of deformation techniques performed on any given character, while ensuring that the generative process yields a high amount of recognizable artificially generated characters. This intelligent reduction of rule processing greatly reduces computing resources and speeds through the generative process at least by intelligently avoiding ineffective deformation techniques. Further, as deformation techniques are used and tested for accuracy data, the accuracy data may be fed into a machine learning module that dynamically effects alignment classifiers, deformation classifiers, and/or deformational rule banks.

In step 307, a system performs character deformation using the selected deformational rules. Example calculations are as follows:

D(C)={D(p₁), D(p₂), D(p₃), . . . D(pₙ)}. Equation 1:

D(pᵢ)=(xᵢ, yᵢ)+(Dₓ, D_{y})=(xᵢ, yᵢ)+(fₓ(xᵢ, yᵢ), f_{y}(xᵢ, yᵢ))=pᵢ+D,

wherein Dᵢ is the displacement vector

Dᵢ=(fₓ(xᵢ, yᵢ), f_{y}(xᵢ, yᵢ)). Equation 2:

D(pᵢ)=(xᵢ, yᵢ) (f(x_{i)_}, f(yᵢ)), Equation 3:

which gives the deformation for Character C.

An example one dimensional (1D) deformation transformation using trigonometric is as follows: f(x)=λ*x[sin(pᵢ*β*x+α)*cos(pᵢ*β*x+α)+δ), wherein when α=0, β=1, and δ=0; the calculation is as follows: f(x)=λ*x[sin pᵢ*x cos pᵢ*x].

With different a parameter, the system may control the degree of non-linear deformation with curve and compression. For example, with y=mx+b, wherein F(0)=0, f(1)=0,

δ=−sin(b)cos(b), α=a, and β=(b−a)/pᵢ, it follows:

D(xᵢ)=xᵢ+λ*x[sin[(b−a)xᵢ+a]cos[(b−a)xᵢ+a]−sin (b)cos (b)],

and

D(yᵢ)=yᵢ+λ*y[sin[(b−a)yᵢ+a]cos[(b−a)yᵢ+a]−sin (b)cos (h)],

wherein 0≤a<b≤1 and λ is a constant. The deformation varies with different [a,b] and different deformation parameters λ.

In embodiments, a system generates deformed characters by performing selected deformation techniques on the original training input data of 301. In this example, step 307 generates eight different deformed characters 310-324 at least by performing the deformation techniques, and/or combination of techniques, selected at step 305 on the Chinese character shown in step 301.

In embodiments, the system may test the artificially generated deformed characters for accuracy data, wherein recognizable artificially generated deformed characters are maintained and unrecognizable artificially generated deformed characters are discarded. Additionally and/or alternatively, further morphing techniques may be performed on some or all of the artificially generated deformed characters, as is described in example discrimination step 209.

FIG. 4 shows method 400, which illustrates an example of discrimination step 209 of FIG. 2A. At step 401, a system receives artificially generated deformed characters. In embodiments, multiple artificially generated deformed characters may be received, for example the eight different artificially generated deformed characters 310-324 of FIG. 3A. If multiple artificially generated deformed characters are received, the system may parallel process steps of FIG. 4, for example, according to the number of artificially generated deformed characters received. In step 403, a system determines whether a received artificially generated deformed character is new personalized data. If the artificially generated deformed character is new personalized data, then the method moves to step 405, which creates a new signature model based at least on the artificially generated deformed character. In step 407, the system updates a current signature model based at least on the new signature model. The pyre-updated version of the current signature model was known to the system prior to step 407. After the update of step 407, the updated version of the current signature model replaces the pre-updated version of the current signature model for future discriminative processing purposes. Thereafter, the process moves to step 409.

If at step 403 the artificially generated deformed character is not classified as new personalized data, then the method moves to step 409. At step 409, a system blends the artificially generated deformed character with the current signature model. At step 411, the system performs matching, e.g., by matching the signature blended artificially generated deformed character to one or more known characters. In the present example, the system may match the signature blended artificially generated deformed character to the Chinese character having the English meaning “big” and generate accuracy data therefrom. At step 413, the system may perform a similarity ranking, e.g., by ranking the similarity between the signature blended artificially generated deformed character and its matched character(s) from step 411. Accuracy data may be generated during this step. At step 415, the system may perform correlation, e.g., by measuring the interdependence of variable quantities between the signature blended artificially generated deformed character and its matched character(s) from step 411. Accuracy data may be generated during this step. Any number of accuracy tests may be performed that identify a reconcilability level of the signature blended artificially generated deformed character to a known character. Steps 411-415 are examples of a variety of accuracy testing the system may perform. The accuracy data of steps 411-415 (and/or any step discussed herein) may be fed into a machine learning module to improve the updating of step 407, the blending of step 406, any morphing and/or selection step and/or any step discussed herein.

At step 417, the system outputs a new personalized generated pattern of the character, and in embodiments, its respective accuracy data. If multiple artificially generated deformed characters were received at step 401, for example the eight different artificially generated deformed characters 310-324 of FIG. 3A, step 417 may output multiple new personalized generated patterns of the character and their respective accuracy data. In embodiments, the output new personalized generated pattern of the character and/or the respective accuracy data (of step 417) may be input into step 211 and or step 215 of FIG. 2A, which is described in detail above.

Those of skill in the art would understand that some of the steps of the various methods described above may be performed in a different sequential order as is discussed herein. Further, some of the steps of the various methods described above may be omitted if desired and/or from time to time. Further still, one or more processors may perform various steps of the various methods described above and may communicate with one another, if desired, at any point during one or more processes via a wired and/or wireless communications network. Yet further, those of skill in the art would understand that one or more machine learning modules may perform machine learning as described above. Further one or more machine learning modules may be one or more dedicated processors and/or executed by one or more non-dedicated processors.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in the figures may comprise processors, electronics devices, hardware devices, electronics components, logical circuits, memories, software codes, firmware codes, etc., and/or any combination thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g, a combination off DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers, Combinations of the above should also be included within the scope of computer-readable media.

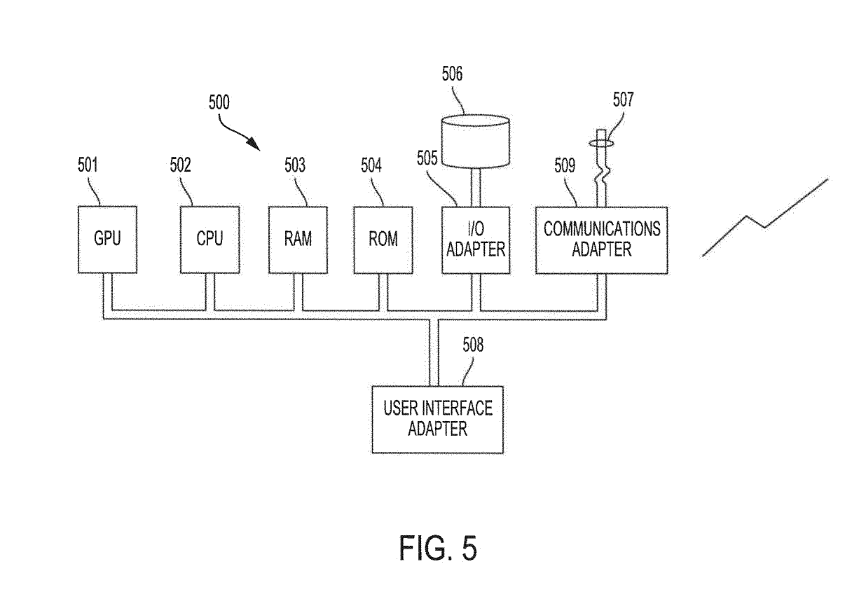

FIG. 5 illustrates an example computer system 500 adapted according to embodiments herein. That is, computer system 500 comprises an example system on which embodiments disclosed herein may be implemented. Graphics processing unit (GPU) 501 and central processing unit (CPU) 502 are coupled to one or more system bus 502, in embodiments, one or more GPUs and/or CPUs may execute machine-level instructions according to the exemplary operational flows described above. Computer system 500 also preferably includes one or more random access memory (RAM) 503 and/or read-only memory (ROM) 504. Computer system 500 also preferably includes one or more input/output (I/O) adapter 505, communications adapter 509, and user interface adapter 508. I/O adapter 505, user interface adapter 508, and/or communications adapter 509 may support wired and/or wireless communications and enable a user, other CPU(s), and/or other CPU(s) to interact with computer system 500. I/O adapter 505 preferably connects to one or more local and/or remote storage device 506 that stores information, for example a character bank, a deformational rule bank, computer executable programs, and/or the like. Communications adapter 509 is preferably adapted to couple computer system 500 to network 512 (e.g., artificial, neural, public, private, WAN, LAN, Internet, cellular, and/or the like), which may be wired and/or wireless. User interface adapter 508 couples user input/output devices.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method that progressively trains a computer to artificially generate recognizable handwritten characters, the method comprising:
receiving a digitized seed character comprising pixels;
choosing at least one feature of the seed character;
determining a probability distribution of the pixels of the chosen feature;
artificially generating deformed characters at least by:
performing physiognomy gridline repositioning based on positions of the pixels,
defining alignment classifiers based at least on the gridline repositioning, and
identifying deformation classifiers based at least on the alignment classifiers, and
selecting one or more deformational rules from a deformational rule bank based at least on the deformation classifiers, and
deforming the digitized seed character according to the selected one or more deformational rules;
collecting accuracy data; and
altering the selecting step based at least on the accuracy data.

2. The method of claim 1 wherein the performing physiognomy grid repositioning comprises:
overlaying the pixels with a grid comprising gridlines; and
adjusting the gridlines based at least on a relative position of a pixel as compared to positions of gridline intersections.

3. The method of claim 2 wherein the relative position of a pixel is defined by a vector distance between the pixel and a gridline intersection.

4. The method of claim 1 wherein performing physiognomy gridline adjusting changes a quantity of the gridlines.

5. The method of claim 1 further comprising:
receiving the artificially generated deformed characters; and
implementing discriminative rules on the artificially generated deformed characters at least by:
blending the artificially generated deformed characters with a current signature model thereby creating personalized artificially generated characters.

6. The method of claim 5 further comprising:
classifying the received artificially generated deformed characters as new personalized data; and
based on the classifying, updating the current signature model based at least on the new personalized data.

7. The method of claim 6 wherein the implementing further comprises performing at least one of: matching, similarity ranking, and correlation, and
wherein the accuracy data collected at least from one of:
the matching,
the similarity ranking, and
the correlation.

8. The method of claim 1 wherein the character is a handwritten Chinese character.

9. The method of claim 1 further comprising:
determining that the artificially generating deformed characters is recognizable as the seed character; and
adding the artificially generating deformed characters to a character bank that stores handwritten characters.

10. The method of claim 1 wherein the feature is one of:
density,
displacement,
pressure, and
acceleration.

11. The method of claim 1 wherein the choosing chooses a plurality of features, wherein the method parallel processes the plurality features to artificially generate a respective plurality of artificially generated characters based on the respective features.

12. A non-transitory computer-readable medium having program code recorded thereon for progressively training a computer to artificially generate recognizable handwritten. characters, the program code comprising:
code to receive a digitized seed character comprising pixels;
code to choose at least one feature of the seed character;
code to determine a probability distribution of the pixels of the chosen feature;
code to artificially generate deformed characters at least by:
performing physiognomy gridline adjusting based on positions of the pixels,
defining alignment classifiers based at least on the gridline repositioning, and
identifying deformation classifiers based at least on the alignment classifiers, and
selecting one or more deformational rules from a deformational rule bank based at least on the deformation classifiers, and
deforming the digitized seed character according to the selected one or more deformational rules;
code to collect accuracy data; and
code to alter the selecting step based at least on the accuracy data.

13. The non-transitory computer-readable medium of claim 12, wherein the performing physiognomy grid adjusting comprises:
overlaying the pixels with a grid comprising gridlines; and
adjusting the gridlines based at least on a relative position of a pixel as compared to positions of gridline intersections.

14. The non-transitory computer-readable medium of claim 12, wherein the relative position of a pixel is defined by a vector distance between the pixel and a gridline intersection.

15. The non-transitory computer-readable medium of claim 12, wherein performing physiognomy gridline adjusting changes a quantity of the gridlines.

16. The non-transitory computer-readable medium of claim 12, wherein the program code further comprises:
code to receive the artificially generated deformed characters; and
code to implement discriminative rules on the artificially generated deformed characters at least by:
blending the artificially generated deformed characters with a current signature model thereby creating personalized artificially generated characters.

17. The non-transitory computer-readable medium of claim 16, wherein the program code further comprises:
code to classify the received artificially generated deformed characters as new personalized data; and
code to update the current signature model based at least on the new personalized data, based on the classifying.

18. The non-transitory computer-readable medium of claim 16, wherein the code to implement further comprises code to perform at least one of: matching, similarity ranking, and correlation, and
wherein the accuracy data collected at least from one of:
the matching,
the similarity ranking, and
the correlation.

19. The non-transitory computer-readable medium of claim 12, wherein the character is a handwritten Chinese character.

20. The non-transitory computer-readable medium of claim 12, wherein the program code further comprises:
code to determine that the artificially generating deformed characters is recognizable as the seed character; and
code to add the artificially generating deformed characters to a character bank that stores handwritten characters.

21. The non-transitory computer-readable medium of claim 12, wherein the feature is one of:
density,
displacement,
pressure, and
acceleration.

22. The non-transitory computer-readable medium of claim 12, wherein the code to choose chooses a plurality of features, wherein the computer parallel processes the plurality features to artificially generate a respective plurality of artificially generated characters based on the respective features.

23. A system that progressively trains machine learning to artificially generate recognizable handwritten characters, the system comprising:
one or more memory; and
one or more processor that receives a digitized seed character comprising pixels, chooses at least one feature of the seed character, determines a probability distribution of the pixels of the chosen feature, and artificially generates deformed characters at least by:
performing physiognomy gridline adjusting based on positions of the pixels,
defining alignment classifiers based at least on the gridline repositioning, and
identifying deformation classifiers based at least on the alignment classifiers, and
selecting one or more deformational rules from a deformational rule bank based at least on the deformation classifiers, and
deforming the digitized seed character according to the selected one or more deformational rules, where
the one or more processor further collects accuracy data, and alters the selecting step based at least on the accuracy data.

24. The system of claim 23, wherein the performing physiognomy grid adjusting comprises:
overlaying the pixels with a grid comprising gridlines; and
adjusting the gridlines based at least on a relative position of a pixel as compared to positions of gridline intersections.

25. The system of claim 23, wherein the relative position of a pixel is defined by a vector distance between the pixel and a gridline intersection.

26. The system of claim 23, wherein performing physiognomy gridline adjusting changes a quantity of the gridlines.

27. The system of claim 23, wherein the one or more processor further receives the artificially generated deformed characters and implements discriminative rules on the artificially generated deformed characters at least by blending the artificially generated deformed characters with a current signature model thereby creating personalized artificially generated characters.

28. The system of claim 27, wherein the one or more processor further classifies the received artificially generated deformed characters as new personalized data, and updates the current signature model based at least on the new personalized data, based on the classifying.

29. The system of claim 27, wherein the one or more processor performs the implementing by performing at least one of: matching, similarity ranking, and correlation, and
wherein the accuracy data collected at least from one of:
the matching,
the similarity ranking, and
the correlation.

30. The system of claim 23, wherein the character is a handwritten Chinese character.

31. The system of claim 23, wherein the one or more processor further determines that the artificially generating deformed characters are recognizable as the seed character and adds the artificially generating deformed characters to a character bank that stores handwritten characters.

32. The system of claim 23, wherein the feature is one of:
density,
displacement,
pressure, and
acceleration.

33. The system of claim 23, wherein the choosing chooses a plurality of features, and wherein the one or more processor parallel processes the plurality features to artificially generate a respective plurality of artificially generated characters based on the respective features.
